(19) United States
(12) Patent Application Publication
(10) Pub. No.: US 2017/0076406 A1
(43) Pub. Date: Mar. 16, 2017

(54) SYSTEMS AND METHOD OF MONITORING PROCESSING SYSTEMS

(71) Applicant: General Electric Company, Schenectady, NY (US)

(72) Inventors: Johan RADEMAN, Johannesburg (ZA); Frederik Johannes WOLFAARDT, Johannesburg (ZA); Kenneth Erwin SCHOLEY, Mississauga (CA)

(21) Appl. No.: 14/936,752

(22) Filed: Nov. 10, 2015

Related U.S. Application Data
(60) Provisional application No. 62/218,714, filed on Sep. 15, 2015.

(51) Int. Cl. G06Q 50/02; H04L 12/58; G06Q 10/06; G06F 17/30

(52) U.S. Cl. CPC G06Q 50/02; G06F 17/30477; H04L 51/046; G06F 17/30294; G06Q 10/06393; G06Q 10/067

(57) ABSTRACT

Approaches are provided where data relating to mining processing system performance parameters of a mining processing system is captured and stored in a memory storage device. The data is obtained at disparate time frequencies, and is obtained by one or more of automatically reading sensors or receiving manual input from an operator. The data is prepared in a format that is consumable by a similarity-based modeling module. The module includes a model of the mining processing system using the mining processing system performance parameters. The data is compared to the model. When the data occurs outside a predetermined range, a communication is transmitted to a user.

### CROSS-REFERENCE TO RELATED APPLICATION

This non-provisional application claims the benefit under 35 U.S.C. §119(e) to U.S. Provisional Application 62/218,714 entitled “Systems And Method Of Monitoring Processing Systems,” filed Sep. 15, 2015, the content of which is incorporated herein by reference in its entirety.

### BACKGROUND OF THE INVENTION

Field of the Invention

The subject matter disclosed herein generally relates to monitoring processing systems. More specifically, the subject matter relates to remotely monitoring characteristics of processing systems, such as system integrity and parameters of various elements of mining processing systems.

The infrastructure of mining processing systems is extensive. From the extraction of ore, to the liberation and separation stage, and through the smelting/leaching/refining stages, minerals are passed through various treatment equipment and facilities.

In the smelting stage, a metal is extracted from its ore or concentrate by a process involving heating and usually melting. In one type of smelting furnace, known as an electric smelting furnace, electricity is used to create heat to melt ore or concentrate in the furnace. In another type of smelting furnace, known as a flash smelting furnace, concentrate and air are fed into a furnace and a chemical reaction generates the heat. In both types of smelting furnaces, components of the materials are heated above the melting points and form a liquid bath within the furnace. In the liquid state, the materials are separated into a metal/matte layer (a molten layer comprising valued metals) and a slag layer (a molten layer comprising primarily oxides that is waste). Due to differences in densities, the metal/matte layer settles below the slag layer in the molten bath.

Production and efficiency at the various stages throughout the mining processing system, such as at the smelting stage, are often a function of performance and/or operational parameters of the equipment used at the facilities. However, due to the nature of the process, obtaining accurate and reliable measurements is difficult or not feasible. For example, due to the harsh and changing conditions prevalent in a smelting furnace, accurate measurements for parameters such as tap-hole wear, freeze-lining thickness, bath levels and thermal conditions in the bath are not reliably achievable. This information needs to be inferred from other available sensory information, such as conditions in the cooling water system, furnace processing parameters such as feed rates and applied electricity, furnace movements upon heating or cooling, thermocouple measurements embedded in the brickwork of the smelting furnace, temperature measurements positioned in and around the copper plate elements built into the furnace wall around the tap-hole, and tapping temperatures and times.

When monitoring for unwanted furnace events such as shell or tap-hole leaks or run-outs, operations typically rely on univariate alarm limits enforced on indirectly related parameters. Due to the highly complex and variable conditions in typical furnaces as well as the delayed response times, these limits are often set very wide to prevent continuous alarm events. Such a univariate approach to monitoring conditions greatly decreases the ability to pre-emptively detect and diagnose the development of undesirable events.

The above-mentioned problems have resulted in decreased production, decreased efficiency, and dissatisfaction with current mining processing system monitoring.

### BRIEF DESCRIPTION OF THE INVENTION

The approaches described herein provide for monitoring, analyzing, and acting upon information obtained from equipment used in mining processing systems. Multivariate and rules based modeling approaches are applied to the obtained information for the detection and reporting of the system integrity.

In many of these embodiments, data relating to mining processing system performance parameters of a mining processing system is captured. The data may be stored in a memory storage device. In some approaches, the data is obtained at disparate time frequencies. The data may be obtained by automatically reading sensors and/or receiving manual input from an operator.

In some embodiments, the data is prepared in a format that is consumable by a similarity-based modeling module. The module includes a model of the mining processing system using the mining processing system performance parameters.

The captured data is compared to the model at the similarity-based modeling module. When the data occurs outside a predetermined range, a communication is transmitted to a user.

In other approaches, an apparatus includes an interface having an input and an output. The input is configured to receive captured data that relates to mining processing system performance parameters of a mining processing system. In some embodiments, the data is obtained at disparate time frequencies. The data is obtained by automatically reading sensors and/or by receiving manual input from an operator. The data is prepared in a format that is consumable by a similarity-based modeling module. Some data has to be cleaned to remove erroneous information or has to be interpolated in a sensible manner to fill in gaps.

The apparatus also includes a memory device configured to store the data.

The apparatus also includes a control circuit that is coupled to the interface and is configured to obtain, via the input, the data. The control circuit compares the data to a model of the mining processing system that is based on the mining processing system performance parameters. The control circuit transmits, via the output, a communication to a user when the data occurs outside a predetermined range. The control circuit can also be configured to make process changes directly in a closed loop.

### BRIEF DESCRIPTION OF THE DRAWINGS

For a more complete understanding of the disclosure, reference should be made to the following detailed description and accompanying drawings wherein:

FIG. 1 comprises a block diagram illustrating an exemplary apparatus for monitoring mining processing systems according to various embodiments of the present invention;

FIG. 2 comprises an operational flow chart illustrating an approach for monitoring mining processing systems according to various embodiments of the present invention;

FIG. 3 comprises an exemplary illustration of a mining processing system according to various embodiments of the present invention;

FIG. 4 comprises an exemplary illustration of a smelting furnace according to various embodiments of the present invention;

FIG. 5 comprises an exemplary illustration of a smelting furnace according to various embodiments of the present invention;

FIG. 6 comprises an exemplary illustration of an array of sensors associated with a smelting furnace according to various embodiments of the present invention;

FIG. 7 comprises an exemplary illustration of an array of sensors associated with a smelting furnace according to various embodiments of the present invention; and

FIG. 8 comprises an exemplary illustration of an array of sensors associated with a smelting furnace according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

Approaches are provided for monitoring performance and operational parameters of various types of equipment used in mining processing systems. The approaches incorporate various operational parameters detected across complex machines such as smelting furnaces. This data may be automatically read by sensors located at various locations of the machines, or may be manually entered by an operator. This allows for the capturing of the complex interrelationships and interactions between the different measured parameters.

Multivariate and rules based modelling technology are then applied to the measurements for the detection and reporting of the deterioration or deviation in the condition or integrity of the machine. This robust, multivariate monitoring approach allows for collective consideration of all the available sensory information, and thus the detection and diagnosis of very small changes or shifts in conditions, as well as deterioration in machine integrity. The collective consideration and prioritization of detected anomalies allows for the early identification of the development of issues, and the possible mitigation thereof.

The approaches described herein allow for both improved diagnostics and a more predictive maintenance approach to maximize production and efficiency across all stages of a mining processing system. The approaches described herein further allow for improved determination of the health and safe trending of complex processes and mechanical systems through comprehensive analytics and rapid reference to historical data.

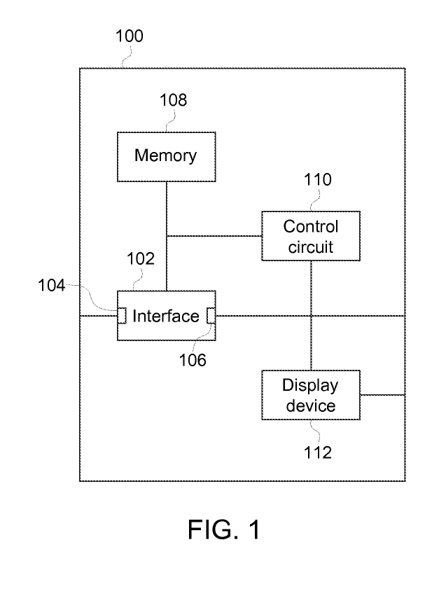

With reference now to FIG. 1, an apparatus 100 includes an interface 102 having an input 104 and an output 106. The input 104 is configured to receive captured data that relates to mining processing system performance parameters of a mining processing system. For example, as discussed in greater detail elsewhere herein, the data may be captured at one or more sensors located in proximity to a smelting furnace.

In some approaches, the data is obtained by automatically reading sensors. For example, “online” sensors capture data related to the mining processing system, and the captured data is transmitted in real time from the sensors to the input 104.

In addition to traditional acquisition of data relating to mining processing system performance parameters, other approaches provide for use of virtual or soft sensor technologies. Soft sensor technologies include inferential modeling applications that utilize known data across a system and system models to provide inferential values (e.g., data estimations or predictions). The inferential values may include, for example, parameters that are difficult to directly measure or monitor through traditional hardware sensors. The inferential values may also include parameters that are based on recurring measurements accumulated over periods of time. In one example, such measurements include furnace attributes such as basicity, pH, and Cr-content that are acquired manually over predetermined intervals (e.g., eight hours). In another example, a pH probe that monitors pH levels in a causticiser sample a pH value over predetermined intervals. In either example, a soft sensor application is able provide to a continuous, real-time indication of the compositional attribute over time, including between the predetermined intervals. Soft sensor technologies may also be used as a back-up to hardware sensors. For example, various sensors may become coated or otherwise fail over time. In such instances, a soft sensor application monitoring the various parameters across the system may be used to make inferential determinations.

In other approaches, the data is obtained by receiving manual input from an operator. These approaches allow for input of data obtained at disparate time frequencies. One example of disparately obtained data is data obtained from laboratory analyses from laboratory information management systems, such as chemical analyses of matte and slag composition. Such information may be manually input by an operator. Other manually input information includes, for example, phase levels, slag temperatures, matte temperatures, supervisory control and data acquisition (SCADA) data, and data from log sheets associated with equipment used in mining processing systems. Thus, it is apparent that the manner in which the data is obtained often is a function of the type of data.

In some aspects, the data is prepared in a format that is consumable by a similarity-based modeling module. This may include, for example, transposing, parsing, and/or formatting the data, resampling and/or aggregating the data, combining data from multiple sources, interpolating data, and validating the data (e.g., performing quality and limit checking).

The apparatus 100 further includes a memory device 108 that is configured to store the data received at the input 104 of the interface 102. In one approach, the memory device 108 is disposed in a traditional physical computer system environment. In this approach, the memory device 108 is disposed in close proximity to the interface 102. For example, both the interface 102 may be disposed within a housing of the apparatus 100, and the memory device 108 may be connected to the interface 102 via hardwire connection. In another approach, the memory device 108 is disposed in a virtual environment such as a cloud-based computing environment. The cloud-based computing environment includes computing resources, storage resources, tools, and other components that can be shared by multiple entities. The cloud-based computing environment is accessible over a network by entities that are remotely located. In this way, the memory device 108 may be disposed remotely in relation to the interface 102.

The memory device 108 also includes a model based on the mining processing system performance parameters. The model is developed using past data indicative of good operational performance. The model may include, for example, reference data observations from the sensors or measurements representative of the equipment within the mining processing system. The model may be an estimate of at least one sensor, measurement, or other classification or qualification parameter that characterizes the state of the modeled system.

The apparatus 100 further includes a control circuit 110 coupled to the interface. The control circuit 110 is configured to obtain, via the input 104, the data. The control circuit 110 is further configured to compare the data to the model of the mining processing system that is based on the mining processing system performance parameters. In some aspects, the modeling method employs similarity-based modeling, where in one aspect a mathematical model of a furnace, furnace system, or parts of a furnace is maintained in the memory device 108. The model estimate at a given point in time is a weighted composite of the most similar observations in the reference data to the current observation. Additional information regarding the comparison performed by the control circuit 110 can be found in U.S. Pat. No. 7,403,869, and in U.S. Pat. No. 7,539,597, the contents of both of which are incorporated by reference herein in their entireties.

Similar to the memory device 108, the control circuit 110 in one approach is disposed in a traditional physical computer system environment. In another approach, the control circuit 110 is disposed in a virtual environment such as a cloud-based computing environment. In this approach, the control circuit 110 is configured to remotely communicate with the interface 102 and/or the memory 108 over a network.

As discussed in greater detail elsewhere herein, the obtained data relates to various parameters associated with one or more pieces of equipment used in mining processing systems. As more information is obtained, greater insight into the overall performance of the equipment may be achieved. This multivariate monitoring approach allows the control circuit 110 to consider the complex interrelationships and data structures between parameters of the equipment used in mining processing systems. For example, the parameters may relate to conditions of a furnace tap hole and surrounding cooling elements (including, but not limited to copper plate temperatures on the nose, lintel cooler, flankers, spout, faceplate, inlet and return cooling water temperatures for coolers, waffle coolers, and plate coolers), as well as the thermocouples embedded in the surrounding brick work, under normal operating conditions. Tapping process conditions can also be included, such as molten temperature, duration of tapping, rate and frequency. Applying this multivariate monitoring approach allows for collective consideration of all the available sensory information, and thus the detection and diagnosis of very small changes or shifts in thermal conditions, as well as deterioration in, for example, a furnace shell and/or tap-hole integrity. The collective consideration and prioritization of detected anomalies allows for the early identification of the development of furnace shell and/or tap-hole integrity issues, and the possible mitigation thereof.

The control circuit 110 is further configured to transmit, via the output 106, a communication to a user when the data occurs outside a predetermined range. In one aspect, the control circuit 110 monitors for deviation from expected behavior. For example, based on past behavior under similar conditions, the similarity-based model might expect the cooling water temperature to be 80° C. If the actual cooling water temperature persistently deviates from this expected temperature by more than a predetermined amount, for instance 10° C., the system will trigger a communication.

The communication may include, for example, an alarm (such an audible or visible alert), a display (such as a visual presentation on a monitor), and/or a transmission (such as a text message notification, an email, or an automated telephone call). Different alarm levels may be utilized depending on the degree of deviation from the predetermined range.

The user receiving the communication may be located at the mining processing system, or may be located at a remote facility such as a central monitoring center.

The apparatus 100 optionally includes a display device 112. The display device 112 may be, for example, a computer screen or television monitor. The display device 112 may display information regarding the data obtained at the input 104, the model of the mining processing system that is based on the mining processing system performance parameters, the comparison performed by the control circuit 110, and/or communications transmitted via the output 106 to users. Other examples are possible.

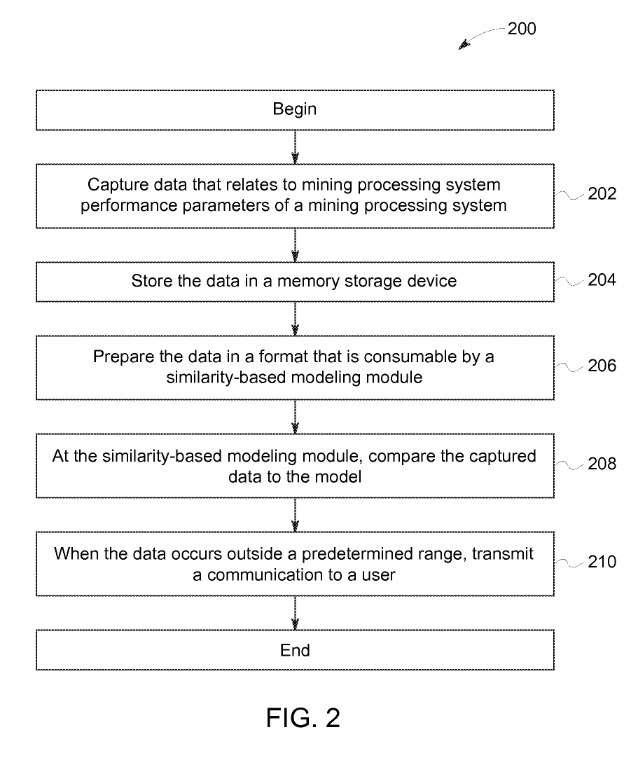

With reference now to FIG. 2, a method 200 includes capturing 202 data that relates to mining processing system performance parameters of a mining processing system. The method 200 further includes storing 204 the data in a memory storage device. As previously discussed, the data may be obtained at disparate time frequencies, and may be obtained by automatically reading sensors and/or receiving manual input from an operator. The method 200 further includes preparing 206 the data in a format that is consumable by a similarity-based modeling module, wherein the module includes a model of the mining processing system using the mining processing system performance parameters. The method 200 also includes, at the similarity-based modeling module, comparing 208 the captured data to the model. The method 200 further includes transmitting 210 a communication to a user when the data occurs outside a predetermined range.

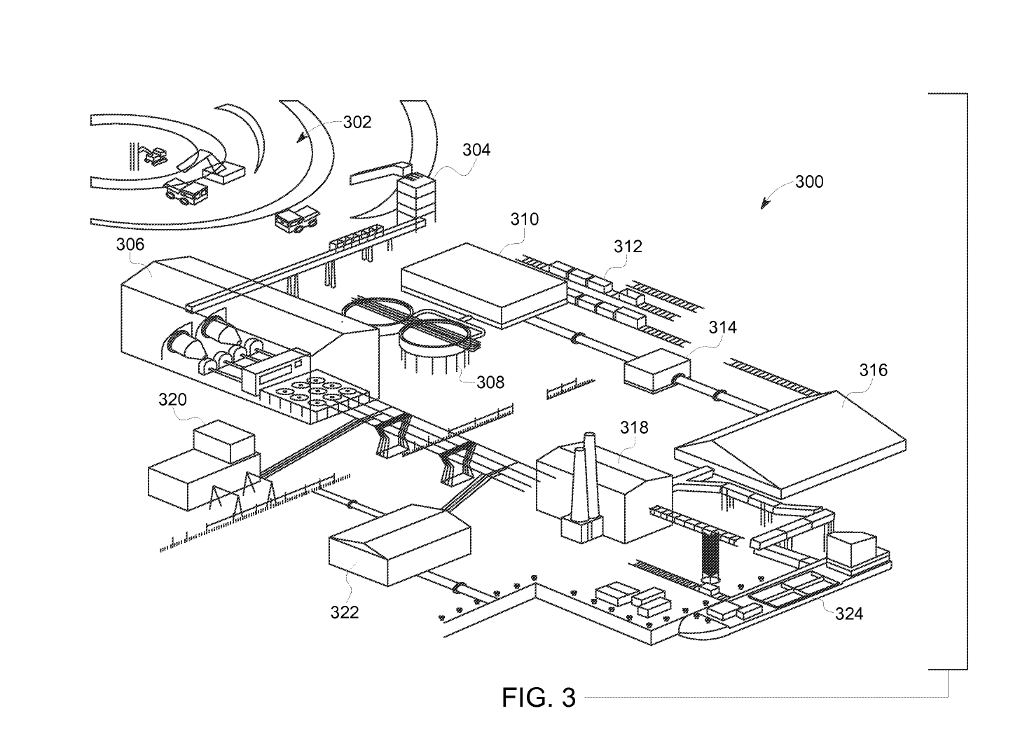

As discussed, the approaches described herein can be applied to various treatment equipment and facilities used in mining processing systems. For example, with reference to FIG. 3, a mining processing system 300 may include mine operations 302, crushing operations 304, comminution operations, concentrator and tailings management operations 306, thickeners 308, drying, conveying and material handling operations 310, transportation operations 312, pump stations 314, refining operations 316, smelting operations 318, utility operations 320, water supply/treatment operations 322, and shipping operations 324. Production and efficiency at facilities shown in the mining processing system 300 of FIG. 3 are often a function of performance and/or operational parameters of the equipment used at the facilities. Sensors associated with the facilities provide data to one or more of the apparatus 100 of FIG. 1 for comparison to model of the mining processing system, as previously discussed.

For example, mine operations 302 include excavators, longwall miners, draglines, and hoists or winders that are monitored. Crushers may be monitored in crushing operations 304. In comminution operations, concentrator and tailings management operations 306, units such as mills, pumps, and flotation banks may be monitored. In thickeners 308, rakes and pumps may be monitored. In another example, drying, conveying and material handling operations 310 may include units such as conveyor belts, blowers, hot gas generators, and bag house units that can be monitored. Haul trucks and locomotives may be monitored in transportation operations 312. Pump stations 314 may include pumps, pump drives, and pump trains that may be monitored. Refining operations 316 may include converters, autoclaves, and electro-winning units that are monitored. In another example, smelting operations 318 may include kilns and furnaces that are monitored. Boilers, chillers, and pumps may be monitored at utility operations 320. At water supply and treatment operations 322, pumps, pump trains, and filtration units may be monitored. In yet another example, shipping operations 324 may include units such as cranes and maritime engines that are monitored. Sensors associated with the example units of the various facilities discussed herein provide data to the apparatus 100 of FIG. 1 for comparison to model of the mining processing system.

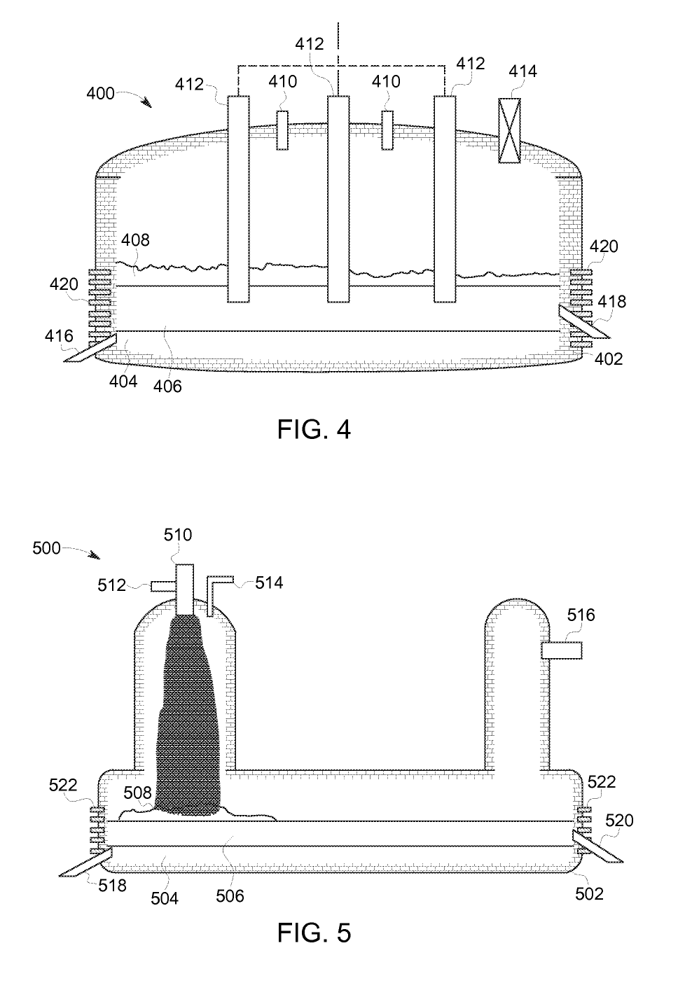

As an example, smelting furnaces, such as those used in smelting operations 318 of FIG. 3, are shown in greater detail in FIG. 4 and FIG. 5. FIG. 4 depicts an electric furnace 400. The electric furnace 400 includes a hearth 402. Sensors associated with the hearth 402 measure hearth refractory temperatures or hearth physical movements. The sensors may also measure sidewall and tidal zone refractory temperatures.

Within the electric furnace 400 is a bath that includes a metal/matte layer 404, slag layer 406, and, in some aspects, a blacktop layer 408. Sensors associated with the bath measure the different phase levels of the components of the bath, compositions of those components, and temperatures of those components.

The electric furnace further includes one or more feedports 410, an electrical energy input comprising one or more electrodes 412, and an offgas system 414. Sensors associated with the feedports 410 capture data regarding feed rate and feed composition. Sensors associated with the electrical energy input capture data regarding the electrical energy supply, including voltage, power, current, electrode height, electrode baking, and paste addition. Sensors associated with the offgas system 414 capture data regarding off-gas temperature and air flow, freeboard temperature, and spray cooler and ducting temperatures.

The metal/matte layer 404 is extracted from the electric furnace 400 via a matte tap hole 416. The slag layer 406 is extracted from the electric furnace 400 via a slag tap hole 418. Sensors associated with the matte tap hole 416 and the slag tap hole 418 capture data regarding the tap holes, including for example, duration of a tap, tap intervals, tap utilization, lances used, clay used (including the type of clay used and the amount of clay used), and metal/matte and slag tapping temperatures at the matte tap hole 416 and the slag tap hole 418. Measurements such as lances, clay used, and type of clay used will be manually captured by an operator in a logsheet.

Surrounding each of the metal/matte tap hole 416 and the slag tap hole 418 are cooling elements 420. Sensors associated with the cooling elements 420 capture data regarding cooling medium inlet flows, inlet and outlet temperatures, pressures, and calculated heat flux. Cooling elements 420 are also associated as part of the overall wall construction away from the metal/matte and slag tap holes.

In one example, the data captured by the sensors discussed with respect to FIG. 4 is transmitted to, and received at, the input 104 of the apparatus 100 of FIG. 1.

FIG. 5 depicts a flash furnace 500. The flash furnace 500 includes a hearth 502. Sensors associated with the hearth 502 measure hearth refractory temperatures. The sensors may also measure sidewall & tidal zone refractory temperatures.

Within the flash furnace 500 is a bath that includes a matte layer 504, slag layer 506, and, in some aspects, a blacktop layer 508. Sensors associated with the composition of the bath measure the different phase levels of the components of the bath, compositions of those components, and temperatures of those components.

The flash furnace 500 further includes a concentrate feed 510, an air/oxygen input 512, and a gas/oil energy supply 514, and an offgas system 516. Sensors associated with the feedports 510 capture data regarding feed rate and feed composition. Sensors associated with the concentrate feed 510, the air input 512, and the gas/oil energy supply 514 capture data regarding flow rate. Sensors associated with the offgas system 516 capture data regarding off-gas temperature and air flow, freeboard temperature, and spray cooler and ducting temperatures.

The matte layer 504 is extracted from the flash furnace 500 via a matte tap hole 518. The slag layer 506 is extracted from the flash furnace 500 via a slag tap hole 520. Sensors associated with the matte tap hole 518 and the slag tap hole 520 capture data regarding the tap holes, including for example, duration of a tap, tap intervals, tap utilization, lances used, clay used (including the type of clay used and the amount of clay used), and slag and matte tapping temperatures at the matte tap hole 518 and the slag tap hole 520.

Surrounding each of the matte tap hole 518 and the slag tap hole 520 are cooling elements 522. Sensors associated with the cooling elements 522 capture data regarding cooling medium inlet flows, inlet and outlet temperatures, pressures, and calculated heat flux.

In one example, the data captured by the sensors discussed with respect to FIG. 5 is transmitted to, and received at, the input 104 of the apparatus 100 of FIG. 1.

Smelting furnaces, such as electric furnace 400 of FIG. 4 and flash furnace 500 of FIG. 5, may additionally include sensors programmed to detect shifts in the furnace. Such sensors are placed in proximity to the furnace (e.g., on the refractory, or on tie-rods positioned about the periphery of the furnace) such that physical movement of the furnace can be detected. This may be accomplished, for example, by sensing changes in the amount of pressure applied to the sensors (located, for example, on compression springs) over time. The data captured by such sensors is transmitted to, and received at, the input 104 of the apparatus 100 of FIG. 1.

It will be appreciated that the approaches discussed herein are adaptable for use with other types of smelting furnaces in addition to the electric furnace 400 of FIG. 4 and the flash furnace 500 of FIG. 5.

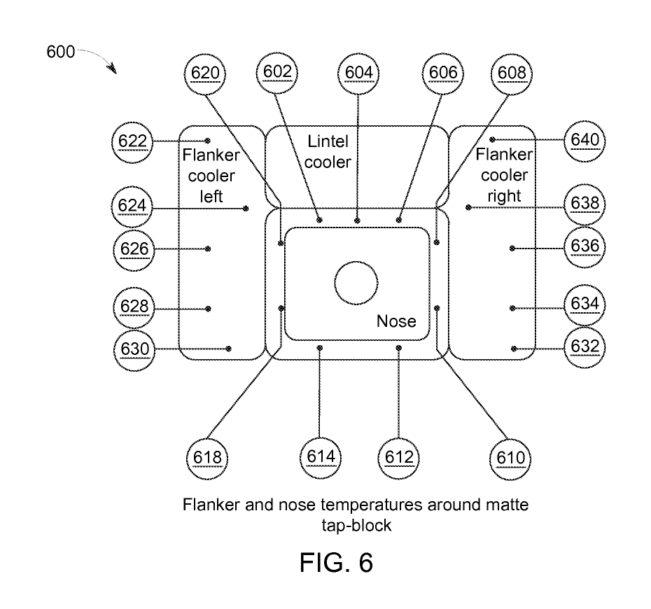

FIG. 6 shows an exemplary illustration of a first array of sensors associated with a smelting furnace 600 (such as a smelting furnace of the smelting operations 318 shown in FIG. 3). The sensors of FIG. 6, identified by reference numerals 602 through 640, measure flanker and nose temperatures, water flow rates, as well as water inlet and outlet temperatures around a matte tap-block of the smelting furnace 600.

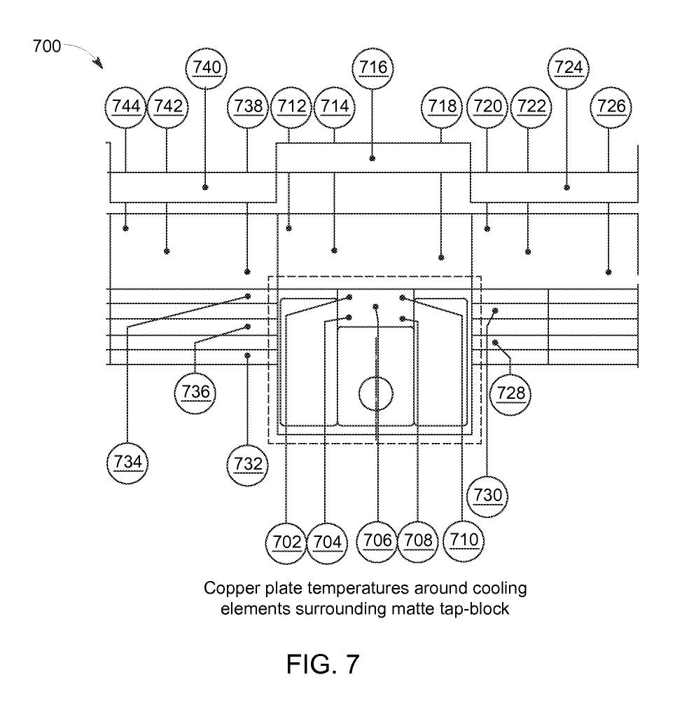

FIG. 7 shows an exemplary illustration of a second array of sensors associated with a smelting furnace 700 (such as a smelting furnace of the smelting operations 318 shown in FIG. 3). The sensors of FIG. 7, identified by reference numerals 702 through 744, measure copper plate temperatures, water flow rates as well as water inlet and outlet temperatures around cooling elements (such as cooling elements 420 of FIG. 4 or cooling elements 522 of FIG. 5) surrounding a matte tap-block of the smelting furnace 700.

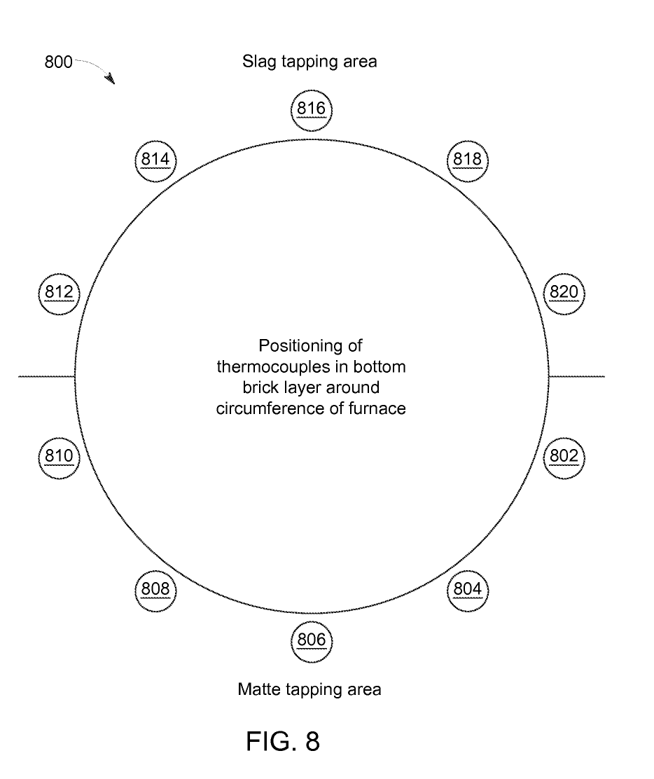

FIG. 8 shows an exemplary illustration of a third array of sensors associated with a smelting furnace 800 (such as a smelting furnace of the smelting operations 318 shown in FIG. 3). The sensors of FIG. 8, identified by reference numerals 802 through 820, include thermocouples, positioning sensors, and/or spring load sensors positioned in or near the bottom brick layer of the smelting furnace 800 around the circumference of the smelting furnace 800.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A method, comprising:
capturing data that relates to mining processing system performance parameters of a mining processing system;
storing the data in a memory storage device, the data being obtained at disparate time frequencies, the data being obtained by one or more of: automatically reading sensors or receiving manual input from an operator;
preparing the data in a format that is consumable by a similarity-based modeling module, the module including a model of the mining processing system using the mining processing system performance parameters;
at the similarity-based modeling module, comparing the captured data to the model; and
when the data occurs outside a predetermined range, transmitting a communication to a user.

2. The method of claim 1, wherein the mining processing system comprises at least one of: a mine operation, a crushing operation, a concentrator, a thickener, a drying and material handling operation, a transportation operation, a pump station, a refining operation, a smelting operation, a utility operation, a water treatment operation, and a shipping operation.

3. The method of claim 1, wherein the data obtained at disparate time frequencies comprises manually entered data.

4. The method of claim 1, wherein the communication is transmitted to a user at the mining processing system.

5. The method of claim 1, wherein the communication is transmitted to a user at a central monitoring center.

6. An apparatus, comprising:
an interface having an input and an output, the input configured to receive captured data that relates to mining processing system performance parameters of a mining processing system, the data obtained at disparate time frequencies, the data obtained by one or more of: automatically reading sensors or receiving manual input from an operator, the data prepared in a format that is consumable by a similarity-based modeling module;
a memory device, the memory device configured to store the data;
a control circuit coupled to the interface;
wherein the control circuit is configured to obtain, via the input, the data, the control circuit further configured to compare the data to a model of the mining processing system that is based on the mining processing system performance parameters, the control circuit further configured to transmit, via the output, a communication to a user when the data occurs outside a predetermined range.

7. The apparatus of claim 6, wherein the mining processing system comprises at least one of: a mine operation, a crushing operation, a concentrator, a thickener, a drying and material handling operation, a transportation operation, a pump station, a refining operation, a smelting operation, a utility operation, a water treatment operation, and a shipping operation.

8. The apparatus of claim 6, wherein the data obtained at disparate time frequencies comprises manually entered data.

9. The apparatus of claim 6, wherein the communication is transmitted to a user at the mining processing system.

10. The apparatus of claim 6, wherein the communication is transmitted to a user at a central monitoring center.
